(19) United States
(12) Patent Application Publication
(10) Pub. No.: US 2005/0058815 A1
(43) Pub. Date: Mar. 17, 2005

(54) Containers having weather resistant graphics on exterior surfaces and process for manufacturing

(76) Inventor: Daniel C. Chick, Houston, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/785,733

(22) Filed: Feb. 24, 2004

Related U.S. Application Data
(63) Continuation-in-part of application No. 10/379,476, filed on Mar. 4, 2003.
Application No. 10/379,476 is a continuation of application No. 09/735,306, filed on Nov. 2, 1999, now abandoned.
Application No. 09/735,306 is a division of application No. 09/013,970, filed on Jan. 27, 1998, now Pat. No. 6,076,332.

(51) Int. Cl. B32B 3/00

(52) U.S. Cl. 428/195.1

(57) ABSTRACT

A thin, transparent polymeric substrate can be used to produce weather resistant graphics on packaging materials. The invention involves printing a reverse image on the transparent polymeric substrate so that the normal image is visible from the opposite side of the substrate. The printed side of the substrate is attached to flat packaging material, such as solid fiberboard, using an adhesive. This process allows the normal image to be visible while the polymeric substrate protects the graphic from the elements. The polymeric substrate also makes the packaging material more weather resistant. Finally, the combined packaging material is cut to form the desired package.

### CROSS-REFERENCE TO RELATED APPLICATIONS

This application is a continuation-in-part application of U.S. Ser. No. 10/379,476 filed on Mar. 4, 2003, which is a continuation of U.S. Ser. No. 09/735,306 filed on Nov. 2, 1999 (now abandoned), which is a division of application of U.S. Ser. No. 09/013,970 filed on Jan. 27, 1998 and issued as U.S. Pat. No. 6,076,332.

### STATEMENT REGARDING FEDERALLY SPONSORED RESEARCH

Not Applicable.

### REFERENCE TO MICROFICHE APPENDIX

Not Applicable.

### SPECIFICATION

1. Field of the Invention

This invention relates to boxes or similar containers. More specifically, this invention relates to a containers having weather resistant graphics on exterior surfaces and to a method to imprint weather resistant graphics on such containers.

2. Background of the Invention

Package manufacturers commonly print graphics on their products. Such graphics serve to identify the goods that will go inside the containers. Package manufacturers commonly use known printing processes, such as silk screening or offset printing, to print graphics on paper stock labels or directly onto fiberboard sheets used to form the box. Such boxes have little or no weather resistance, and the graphics often become faded or ruined when the boxes are exposed to the elements. Some manufactures have begun printing on weather resistant materials, such as vinyl, and applying that material to the fiberboard that forms the box, as disclosed in U.S. Pat. No. 6,076,332. Typically, if a person desires to increase the weather resistance of the graphics and the package, they must use additional, costly steps to protect the print, such as applying an overlaying, protective material over the printed graphics.

The main problem with these known methods is the additional costs associated with adding protective layers to make the graphics and the package more weather resistant. Therefore, there exists a need in the industry for low cost weather resistant graphics that can be applied to fiberboard or other materials used to form boxes. Such weather resistant graphics should also make the package more weather resistant.

### BRIEF SUMMARY OF THE INVENTION

It has been discovered that a properly prepared thin, transparent polymeric substrate, such as polyvinyl, polypropylene, polyester, polyethylene, polycarbonate, poly(vinyl acetate), poly(vinyl acrylic), polystyrene, poly(ethylene terephthalate) (PET), or poly(ethylene terephthalate glycol) (PETG), can be used to produce weather resistant graphics on packaging materials. The invention uses any printing process, such as silk screening or offset printing, to imprint a solventless, ultraviolet ink, onto the substrate. The preferred embodiment involves printing a reverse image on a transparent polymeric substrate so that the normal image is visible from the opposite side of the substrate. The ink is cured, preferably with ultraviolet light, and the printed side of the substrate is attached to flat packaging material, such as solid fiberboard, using an adhesive. This process allows the normal image to be visible while the polymeric substrate protects the graphic from the elements. The polymeric substrate also makes the packaging material more weather resistant. Finally, the combined packaging material is cut to form the desired package.

### BRIEF DESCRIPTION OF THE VIEWS OF THE DRAWINGS

Not Applicable.

### DETAILED DESCRIPTION OF THE INVENTION

This invention relates to containers having weather resistant graphics on exterior surfaces and to a process for printing such graphics on the materials used for packaging. Packaging manufacturers have traditionally used various printing processes on materials, such as paper and cardboard, and then applied protective overlayers to weatherproof the underlying graphics.

The process permits the manufacturer to print weather resistant graphics in an economical and efficient manner on materials that form the containers. This process involves printing a reverse image of the desired graphics onto a transparent, polymeric substrate, such as, for example, polyvinyl, polypropylene, polyester, polyethylene, polycarbonate, poly(vinyl acetate), poly(vinyl acrylic), polystyrene, poly(ethylene terephthalate), or poly(ethylene terephthalate glycol). The process can use any printing method, such as silk screening or offset printing, but offset printing is preferred because of economics and quality of graphics. A preferred example of this process involves using a thin, transparent, polyester sheeting, manufactured by Multie Plastics in Cleveland, Ohio. The polyester sheeting has a thickness of about 4 to about 7 mils, preferably about 4 mils. This polyester sheeting is weather resistant, and it helps make the solid fiber board more weather resistant. This process will also work on corrugated board, but solid fiberboard is preferred.

The preferred process uses a sheet-fed, offset press for printing, although other printing methods, such as silk screening, can be used. With offset printing, the press uses graphics plates to imprint the reverse image onto the thin, transparent, polymeric substrate. It is a preferred feature of this process that the printing process use ultraviolet (UV) inks, which are solventless inks that cure quickly, preferably with the application of UV light. However, it should be understood that other curing techniques are known in the industry. Such inks not only provide sharp images on the polymeric substrate, but they are easily and quickly cured to provide a dry surface which is ready for further processing.

Best results have been obtained when using styrene-based UV inks for imprinting on the thin, transparent, polymeric substrate. Such inks contain high solids, are quick reacting, and are made especially for application on polymeric substrates. After printing, it is necessary that the ink be cured before the substrate is applied to the fiberboard or other package material. Curing is preferable accomplished by the application of UV light. An adhesive, preferable a thin coating of an aggressive acrylic permanent pressure sensitive adhesive, is applied to the imprinted side of the polymeric substrate or to the package material, and the polymeric substrate is permanently adhered to the package material. For best results in the adhesion step, the application process should be conducted under temperature conditions above 65° F.

Because a reverse graphic image is printed on the thin, transparent substrate, the desired graphic is visible though the thin substrate. Furthermore, since the graphic is effectively covered by the thin polymeric substrate after application to the package material, there is no need for any additional protection coating. Not only does the polymeric substrate protect the graphic, but it also provides weather resistance for the package material.

In the last step of the package manufacturing process, the combined package material and printed polymeric substrate is die cut to the desired size and shape and is stitched to form the final packaging product. This final package manufacturing step is well known in the industry and need not be described further.

The foregoing disclosure and description of the invention are illustrative and explanatory thereof, and various changes in the details of the illustrated method of operation may be made without departing from the spirit of the invention.

1. A method for making a package having weather resistant graphics on its exterior, the method comprising:
imprinting a reverse image of a desired graphic on one side of a thin, transparent, polymeric substrate with a solventless, ultraviolet ink;
curing the ink;
adhering the printed side of the polymeric substrate to a package material to form a combined package material and polymeric substrate;
forming the package from the combined package material and polymeric substrate.

2. The method of claim 1 wherein the ink is styrene-based.

3. The method of claim 1 wherein the polymeric substrate is selected from the group consisting of polyvinyl, polypropylene, polyester, polyethylene, polycarbonate, poly(vinyl acetate), poly(vinyl acrylic), polystyrene, poly(ethylene terephthalate), and poly(ethylene terephthalate glycol).

4. The method of claim 1 wherein the package material is made from cellulose.

5. The method of claim 4 wherein the package material is a solid fiberboard.

6. The method of claim 4 wherein the package material is a corrugated board.

7. A method of making a package having weather resistant graphics on its exterior, the method comprising:
imprinting a reverse image of a desired graphic on one side of a thin, transparent polymeric substrate selected from the group consisting of polyvinyl, polypropylene, polyester, polyethylene, polycarbonate, poly(vinyl acetate), poly(vinyl acrylic), polystyrene, poly(ethylene terephthalate), and poly(ethylene terephthalate glycol) substrate with a styrene-based, ultraviolet ink;
curing the ink;
adhering the printed side of the polymeric substrate to a package material to form a combined package material and polymeric substrate;
cutting and stitching the combined package material and polymeric substrate to form the package.

8. The method of claim 7 wherein the package material is a solid fiberboard.

9. The method of claim 7 wherein the package material is a corrugated board.

10. A package having weather resistant graphics on its exterior, the package comprising a package material, and a thin, transparent, polymeric substrate adhered to one side of the package material, the substrate having a reverse graphic image imprinted on the side adhered to the package material such that the desired graphic is visible through the substrate.

11. The package of claim 10 wherein the graphic image is created using a solventless, untraviolet ink.

12. The package of claim 11 wherein the ink is stryene-based.

13. The package of claim 12 wherein the polymeric substrate is polyvinyl, polypropylene, polyester, polyethylene, polycarbonate, poly(vinyl acetate), poly(vinyl acrylic), polystyrene, poly(ethylene terephthalate), or poly(ethylene terephthalate glycol).

14. The package of claim 13 wherein the package material is made from cellulose.

15. The package of claim 14 wherein the cellulose is a solid fiberboard.

16. The package of claim 14 wherein the cellulose is a corrugated board.
